(19) United States
(12) Patent Application Publication
(10) Pub. No.: US 2015/0120576 A1
(43) Pub. Date: Apr. 30, 2015

(54) METHOD AND APPARATUS FOR ALLOWING BUYERS TO PLACE INTENDED PURCHASE OFFERS AND REWARD THE BUYERS FOR THEIR INTENDED PURCHASE OFFERS

(71) Applicant: Vinh NGUYEN, San Jose, CA (US)

(72) Inventor: Vinh NGUYEN, San Jose, CA (US)

(21) Appl. No.: 14/522,556

(22) Filed: Oct. 23, 2014

Related U.S. Application Data
(60) Provisional application No. 61/894,912, filed on Oct. 24, 2013.

(51) Int. Cl. G06Q 30/02; G06Q 50/18; G06Q 30/06

(52) U.S. Cl. CPC G06Q 30/0222; G06Q 30/0611; G06Q 50/188
USPC 705/80; 705/26.4; 705/14.23

(57) ABSTRACT

The invention is a method and apparatus for allowing buyers to place intended purchase offers and rewarding them whenever they receive counter offers from sellers even before they make the purchases. The invention allows prospective buyers of goods or services to communicate their intended purchase offers, to display their offers on the apparatus for sellers to see and to allow sellers to accept or and counter offer. Buyers get rewarded whenever they receive offers from sellers. The apparatus in the invention consists of a central controller to process purchase offers and counter offers, a database to store information about buyers, sellers, their purchase offers and counter offers, an interface for buyers and an interface for sellers.

### CROSS REFERENCE TO RELATED APPLICATIONS

This application claims priority under 35 USC 119 from US Provisional Application Ser. No. 61/894,912 filed on Oct. 24, 2013, titled METHOD AND APPARATUS FOR ALLOWING BUYERS TO PLACE INTENDED PURCHASE OFFERS AND REWARD THE BUYERS FOR THEIR INTENDED PURCHASE OFFERS by NGUYEN, Vinh, the entire disclosure of which is incorporated herein by reference.

### BACKGROUND

There are several systems that buyers and sellers exchange or trade services and/or goods. The majority of them are seller-driven, meaning that sellers advertise, display the products or service to sell and initiate a price for their products or services. The buyers then search for the products or service that they want, compare prices and quality, contact sellers to complete the transaction.

In addition, there are limited numbers of systems where the buyer posts purchase offers. However, they are not popular because of the following reasons. First, buyers have no incentive to place purchase offers. Second, once buyers posts such purchase offers, they could be inundated with irrelevant emails or calls from sellers. The two mentioned reasons discourage buyers from posting what they plan to buy.

### SUMMARY

The present invention provides a method and apparatus to reward buyers for placing their purchase offers in a system, to display the purchase offers globally for sellers to see and to search for relevant purchase offers and to bind or negotiate with and then bind the buyer to a contract with the buyer's intended purchase offers.

The present invention is similar to a job board in which the buyer is a business or a company, looking for an employee and the employee who is a service provider or a seller. In the job board, the business or the company posts its job posting on a job board and the employee acting as a seller searches for the relevant job offer, submit a resume and interview or negotiate with the company to bind an employment contract.

In present invention, the buyer posts or places the purchase offer. The purchase offer is comprised of subject, category, city, quantity, price, expiration date, conditions, buyer id, etc. The purchase offer is then stored in the database and displayed on display monitors globally for sellers to see and also sent to subscribed sellers. The seller then searches for the relevant purchase offer, either accepts the offer or makes a counter-offer in such a way that binds the buyer with a contract.

The buyer gets rewarded whenever contacted by the seller by either email, phone calls or any other means like postal mails. The reward can be points, credits, cash or others and can be applied toward the buyer's current or future purchase offers.

The goal of the present invention is to reward buyers to express or place their purchase offers. Buyers get rewarded when they are contacted by the sellers. When the buyer places a price in the purchase offer, then the offer is bound when accepted by the first seller. When the buyer does not place a price in the purchase offer, then the offer is open for negotiation. The buyer can be contacted by several sellers simultaneously and get rewarded every time being contacted by the sellers.

Another goal of the present invention is to create a “heaven” for sellers since we create and display a centralized purchase offers from buyers. The seller can search for relevant purchase offers, contact the buyer or accept the offer, or counter offer.

Another goal of the present invention is to shorten the transaction cycle between the buyer and the seller. In the case that the buyer places a price in the purchase offer, the buyer is ready to purchase. Once the seller accepts the buyer's offer, a bind contract is established. Even in the case that the buyer does not place a price in the purchase offer, the buyer has already intention to purchase. Once the seller offers a right price and the buyer accepts it, a binding contract is established.

### BRIEF DESCRIPTION OF THE DRAWINGS

The specification disclosed includes the figures, wherein like numbers in the figures represent like numbers in the description and the figures are represented as follows:

FIG. 1 is a block diagram of the system showing the central controller unit, buyer interface, seller interface, display monitor and database.

FIG. 2 is a block diagram of the central controller unit.

FIG. 3 is a block diagram of the seller interface.

FIG. 4 is a block diagram of the buyer interface.

FIG. 5 is a block diagram of the database.

FIG. 6 illustrates the process of how the buyer generates the purchase offer.

FIG. 7 illustrates the interaction between the buyer and the seller about the purchase offer and the buyer get paid after being contacted by the seller.

### DETAILED DESCRIPTION

In accordance with the various aspects of the present invention, the computing devices of the present invention may include a central processing unit, memory, input devices (e.g., keyboard and pointing devices), output devices (e.g., display devices), and storage devices (e.g., disk drives). The memory and storage devices are computer-readable media that may contain instructions. In addition, the data structures and message structures may be stored or transmitted via a data transmission medium, such as a signal on a communications link. Various communications links may be used, such as the Internet, a local area network, a wide area network, or a point-to-point dial-up connection.

The systems of the present invention, in accordance with various aspects and embodiments, may use various computing systems or devices including personal computers, server computers, hand held or laptop devices, multiprocessor systems, microprocessor based systems, programmable consumer electronics, network PCs, minicomputers, mainframe computers, distributed computing environments that include any of the above systems or devices, and the like. The systems may also provide services to various computing systems such as personal computers, cell phones, personal digital assistants, consumer electronics, home automation devices, and so on.

The systems may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the user interface component may be implemented on a server separate from the computer system that generates the information or data.

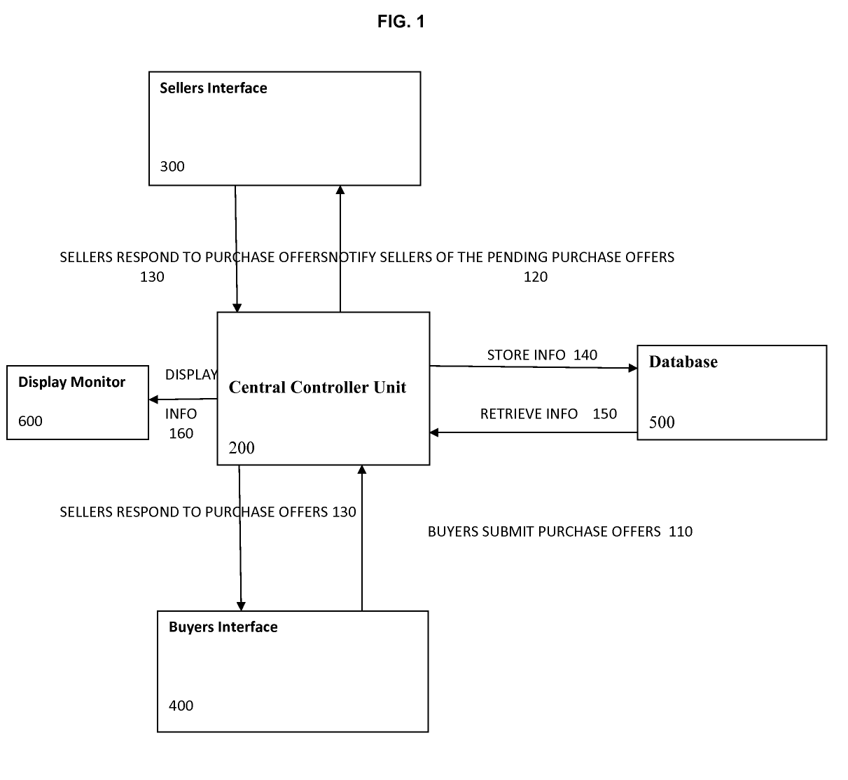

FIG. 1 is a general diagram of the components of the apparatus used in this invention. It is comprised of a central controller unit 200, a seller interface 300, a buyer interface 400, a database 500, and a display monitor 600. A buyer from the buyer interface 400 submits a purchase offer 110 which is received by the central controller unit 200. The purchase offer information 140 is then stored in the database 500. The central controller unit 200 might retrieve purchase offer information 150 to display information 160 at the display monitor 600. The central controller unit 200 will notify sellers of the pending purchase offers 120 to the sellers through seller interface 300. The sellers from seller interface 300 respond to purchase offers 130 to the central controller unit 200 which sends the seller's response to purchase offers 130 to the buyers at the buyer interface 400.

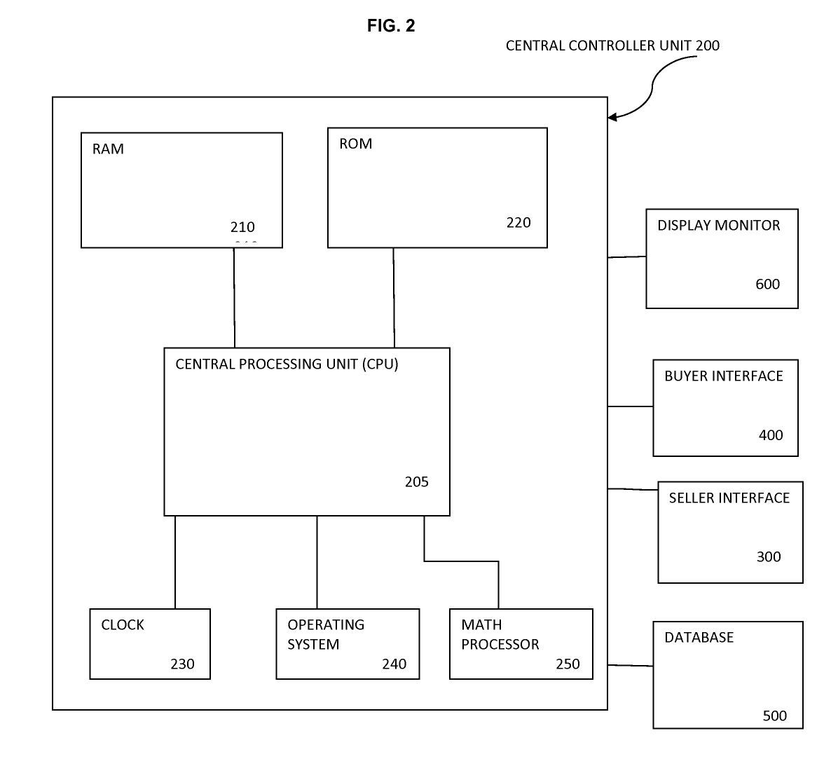

FIG. 2 is a general diagram of the components of the central processing unit 200. It is comprised of a central processing unit (CPU) 205, a random access memory (RAM) 210, a read only memory (ROM) 220, a clock 230, an operating system 240, and a math processor 250.

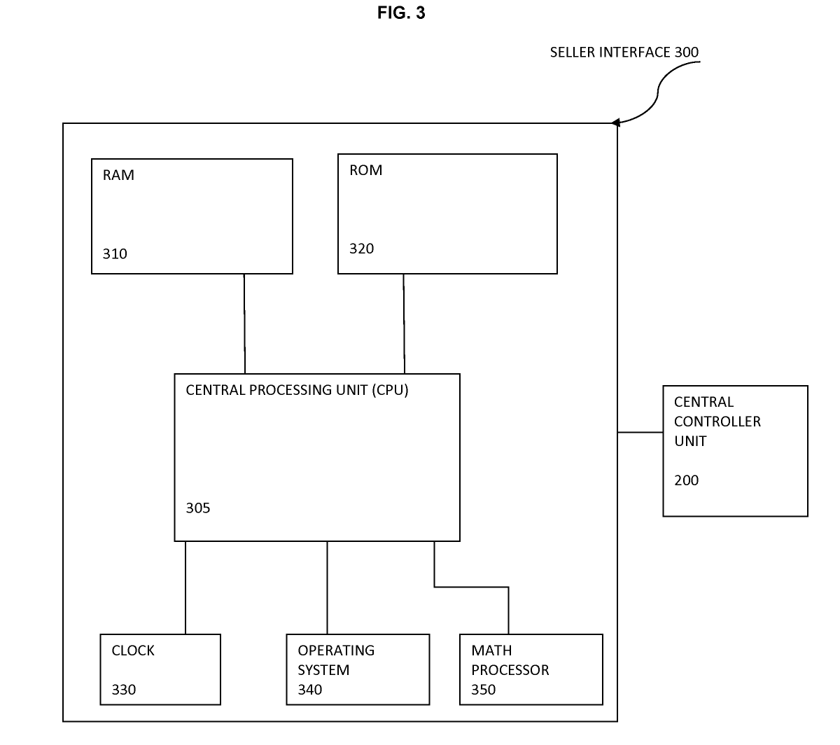

FIG. 3 is a general diagram of the components of the seller interface 300. It is comprised of a central processing unit (CPU) 305, a random access memory (RAM) 310, a read only memory (ROM) 320, a clock 330, an operating system 340, and a math processor 350.

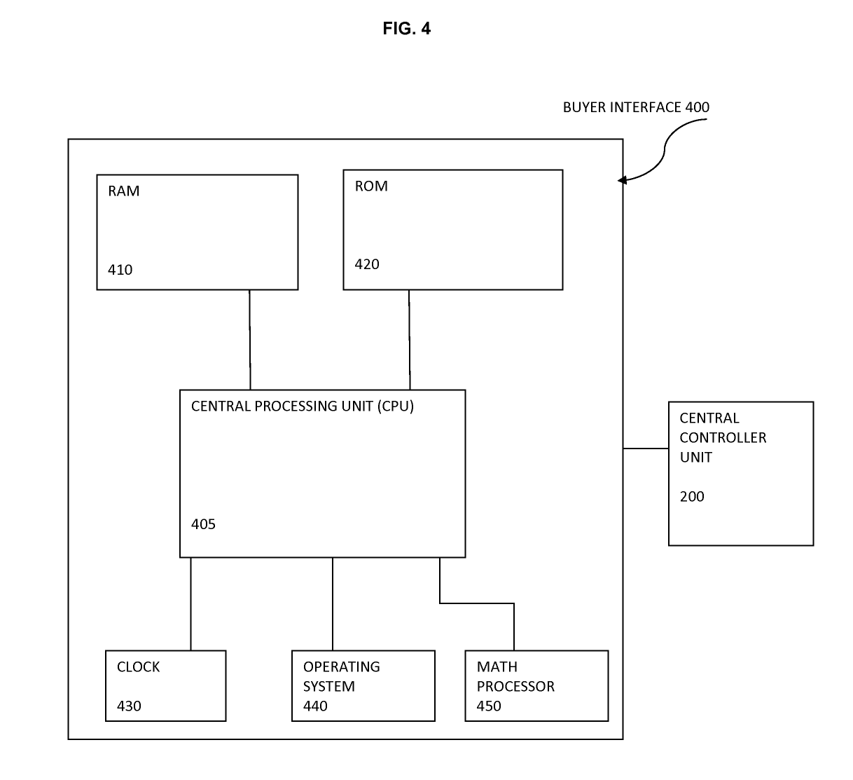

FIG. 4 is a general diagram of the components of the buyer interface 400. It is comprised of a central processing unit (CPU) 405, a random access memory (RAM) 410, a read only memory (ROM) 420, a clock 430, an operating system 440, and a math processor 450.

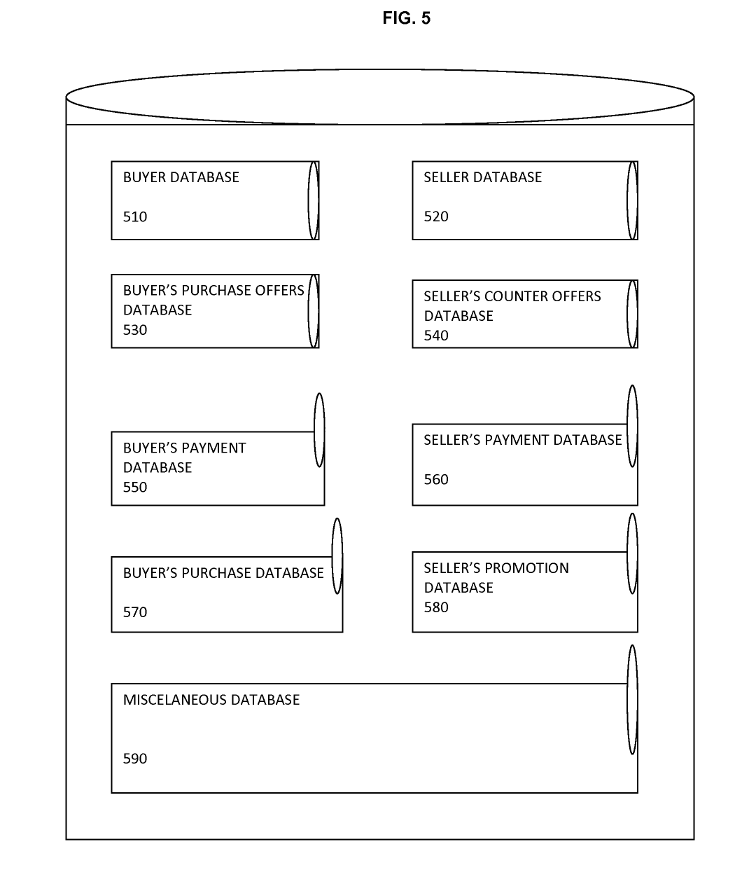

FIG. 5 is a general diagram of the components of the database 500. It is comprised of a buyer database 510, a seller database 520, a buyer's purchase offers database 530, a seller's counter offers database 540, a buyer's payment database 550, a seller's payment database 560, a buyer's purchase database 570, a seller's promotion database 580 and a miscellaneous database 590.

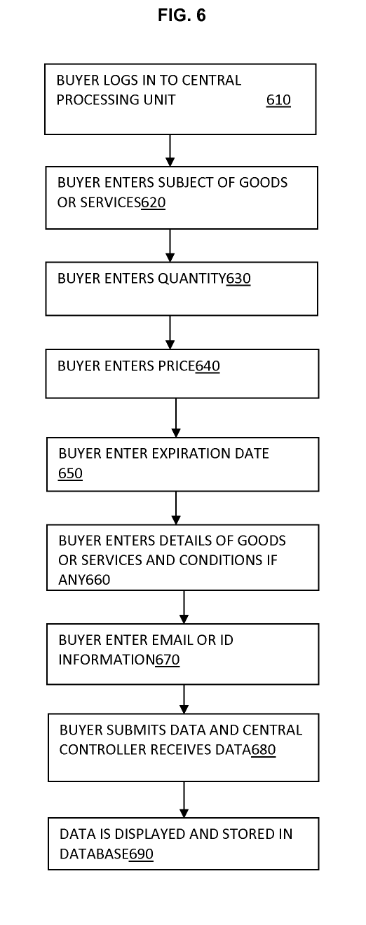

FIG. 6 illustrates how buyers submit purchase offers 110. Using the buyer interface 400, the buyer logs into the central processing unit 200 at step 610. Then at step 620, the buyer enters the subject of the goods or service that is desired to purchase. At step 630, the buyer enters the quantity. The buyer has the option of entering a price at step 640. If the price is entered, then the purchase offer is binding. If the price is not entered, then the purchase offer is not binding. At step 650, the buyer enters an expiration date with the default value of today's date. The buyer must enter details of goods or service and any conditions if any at step 660. For example, in buying an automobile, the buyer might enter the color of the automobile, whether it is an all-wheel drive, fully loaded with all equipment, etc. At step 680, the buyer submits the purchase offer and the central controller 200 receives it. At step 690, the purchase offer is displayed on the display monitor 600 and stored in the buyer's purchase offers database 530.

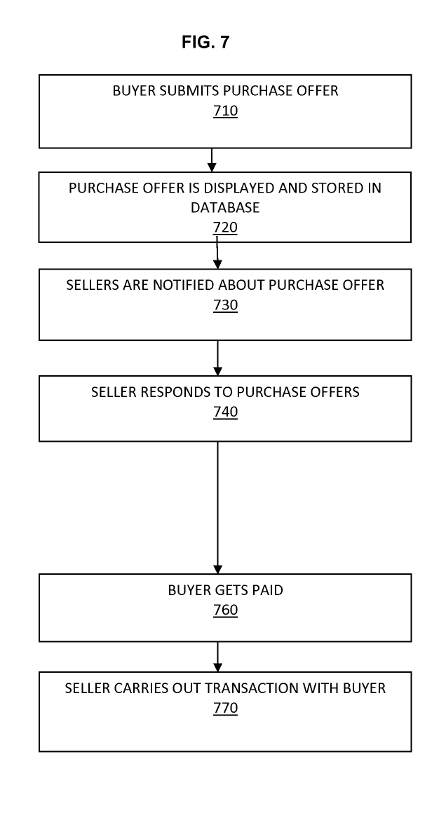

FIG. 7 illustrates the flow of purchase offers made by the buyer and responded by the seller. After the buyer submits the purchase offers 110 at step 710, the purchase offer is displayed in the display monitor 600 and stored the information 140 in the database 500 at step 720. The central controller unit 200 retrieves information 150 from the database 500 and notified sellers of the pending purchase offers 120 at step 730. At step 740, the seller responds to the purchase offers 130. Once the seller responds to the purchase offers 130, the buyer get paid at step 760. At step 770, the seller carries out the transaction with the buyer online at a website or offer through email or telephone.

In accordance with the teachings and aspects of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor, in turn, executes the computer readable program code to create or amend an existing computer-aided design using a tool. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

It can be seen that the invention provides a convenient and economical method for changing the function of a holder based on the user's needs. While particular embodiments of the present invention have been shown and described, those of ordinary skill will appreciate that modifications may be made that fall within the scope and spirit of the invention. In addition, the present invention should not be considered limited to the dimensions of the preferred embodiment described herein.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed:

1. A method for using a system to allow a transaction between a buyer and at least one seller of a plurality of sellers, the method comprising the steps of:
inputting into the system a purchase offer from the buyer;
displaying the purchase offer globally on a plurality of display monitors; and
outputting the purchase offer to the plurality of sellers.

2. The method of claim 1, further comprising:
inputting into the system at least one of:
an acceptance of the purchase offer by the at least one seller; and
a counter-offer from the at least one seller; and
if there is acceptance by the at least one seller, then outputting a reward to the buyer.

3. The method of claim 2, further comprising completing a transaction between the at least one seller and the buyer.

4. The method of claim 2, further comprising inputting into the system at least one of:
a buyer acceptance of the counter-offer; and
a buyer counter-offer to the at least one seller.

5. The method of claim 4, further comprising completing a transaction between the at least one seller and the buyer if there is at least one of the buyer acceptance and the at least one seller's acceptance of the buyer counter-offer.

6. The method of claim 2, further comprising:
inputting into the system at least one of an acceptance by and a counter-offer from the buyer;
inputting into the system at least one of a second acceptance or a second counter-offer from the seller.

7. The method of claim 6, further comprising completing a transaction between the at least one seller and the buyer based on at least one of:
the acceptance;
the at least one seller's acceptance of the counter-offer from the buyer;
the second acceptance; and
the buyer's acceptance of the second-counter offer from the at least one seller.

8. A method comprising:
inputting into a system a purchase offer from a buyer;
inputting into the system a reward granted to the buyer when there is a response from at least one seller from a plurality of sellers;
displaying the purchase offer globally on a plurality of display monitors; and
outputting the purchase offer to the plurality of sellers.

9. The method of claim 8, further comprising inputting into the system at least one of:
an acceptance by at least one seller from the plurality of sellers of the buyer's purchase offer; and
a counter-offer from the at least one seller.

10. The method of claim 9, if there is a counter-offer, then further comprising outputting the reward to the buyer.

11. The method of claim 9, further comprising completing a transaction between the seller and the buyer.

12. The method of claim 8, further comprising inputting into the system at least one of:
acceptance of the purchase offer from the buyer by at least one seller from the plurality of sellers; and
a counter-offer from the seller.

13. The method of claim 12, further comprising completing a transaction between the seller and the buyer.

14. The method of claim 9, further comprising:
inputting into the system at least one of:
an acceptance of the at least one seller's counter-offer; and
a counter-offer from the buyer; and
inputting into the system at least one of:
a second acceptance from the at least one seller of the buyer's counter-offer; and
a second counter-offer from the at least one seller.

15. The method of claim 14, further comprising completing a transaction between the seller and the buyer.

16. The method of claim 8, further comprising:
completing a transaction between the seller and the buyer; and
outputting the reward to the buyer.

17. A system for allowing a transaction between a buyer and at least one seller of a plurality of sellers, the system comprising:
means for inputting into the system a purchase offer from the buyer;
means for displaying the purchase offer globally on a plurality of display monitors; and
means for outputting the purchase offer to the plurality of sellers.
